(19) United States
(12) Patent Application Publication
(10) Pub. No.: US 2024/0292308 A1
(43) Pub. Date: Aug. 29, 2024

(54) METHOD AND APPARATUS FOR HANDOVER OF A USER EQUIPMENT FOR NETWORK ENERGY SAVING IN NEXT GENERATION MOBILE COMMUNICATION SYSTEM

(71) Applicant: Samsung Electronics Co., Ltd., Suwon-si (KR)

(72) Inventors: June HWANG, Suwon-si (KR); Sangyeob JUNG, Suwon-si (KR)

(21) Appl. No.: 18/584,897

(22) Filed: Feb. 22, 2024

(30) Foreign Application Priority Data
Feb. 23, 2023 (KR) 10-2023-0024486

(51) Int. Cl. H04W 36/36; H04W 52/02; H04W 72/232; H04W 76/20

(52) U.S. Cl. CPC H04W 36/362; H04W 52/0206; H04W 72/232; H04W 76/20

(57) ABSTRACT

The present disclosure relates to 5G or 6G communication systems to support higher data transmission rates. The present disclosure a method and apparatus of a UE. The method of the UE comprises: receiving, from a base station, a radio resource control (RRC) message including configuration information associated with a conditional handover (CHO); determining, based on the configuration information, whether an event is satisfied; and performing the CHO based on a determination that the event is satisfied.

### CROSS-REFERENCE TO RELATED APPLICATION

This application is based on and claims priority under 35 U.S.C. § 119 to Korean Patent Application No. 10-2023-0024486, filed on Feb. 23, 2023, in the Korean Intellectual Property Office, the disclosure of which is herein incorporated by reference in its entirety.

### BACKGROUND

### 1. Field

The present disclosure relates to the operation of a user equipment in a mobile communication system. Specifically, the present disclosure relates to a handover technology of the user equipment.

### 2. Description of Related Art

5th generation (5G) mobile communication technologies define broad frequency bands such that high transmission rates and new services are possible, and may be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next generation distributed computing technology for implementing services at levels of complexity exceeding the limit of UE operation capability by utilizing ultra-high-performance communication and computing resources. As various services may be provided according to the above-mentioned and the development of mobile communication systems, a method to effectively provide these services is required.

### SUMMARY

When the base station transitions to a state in which data is not transmitted/received or is turned off and a lot of user equipments are concentrated in a specific cell, collisions may occur in connection operations and overload may occur in the cell.

In accordance with an aspect of the disclosure, a method performed by a user equipment (UE) in a wireless communication system, the method comprising: receiving, from a base station, a radio resource control (RRC) message including a configuration associated with a conditional handover (CHO); identifying whether an event is satisfied based on the configuration; and performing the conditional handover in case that the event is satisfied.

In an embodiment of the disclosure, wherein the event is satisfied, in case that downlink control information (DCI) including an indication associated with a network energy saving (NES) is received from the base station.

In an embodiment of the disclosure, wherein the configuration associated with the CHO includes information indicating the event associated with a NES CHO.

In an embodiment of the disclosure, wherein the indication associated with the NES comprises a 1 bit.

In accordance with an aspect of the disclosure, a method performed by a base station in a wireless communication system, the method comprising: transmitting, to a user equipment (UE), a radio resource control (RRC) message including a configuration associated with a conditional handover (CHO); and performing the conditional handover in case that an event is satisfied based on the configuration.

In accordance with another aspect of the disclosure, a user equipment (UE) in a wireless communication system, the UE comprising: a transceiver; and a controller operably connected to the transceiver, the controller configured to: receive, from a base station, a radio resource control (RRC) message including a configuration associated with a conditional handover (CHO), identify whether an event is satisfied based on the configuration, and perform the conditional handover in case that the event is satisfied.

In accordance with another aspect of the disclosure, a base station in a wireless communication system, the UE comprising: a transceiver; and a controller operably connected to the transceiver, the controller configured to: transmit, to a user equipment (UE), a radio resource control (RRC) message including a configuration associated with a conditional handover (CHO), and perform the conditional handover in case that an event is satisfied based on the configuration.

According to an embodiment of the present disclosure, a user equipment in a connected mode may receive candidate cell configuration information that balances target cells from a serving cell and perform a handover.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a general LTE system according to an embodiment of the present disclosure;

FIG. 2 illustrates a wireless protocol structure of a general LTE system according to an embodiment of the present disclosure;

FIG. 3 illustrates a structure of a next generation mobile communication system according to an embodiment of the present disclosure;

FIG. 4 illustrates a wireless protocol structure of a next generation mobile communication system according to an embodiment of the present disclosure;

FIG. 5 illustrates an internal structure of a UE according to an embodiment of the present disclosure;

FIG. 6 illustrates a configuration of an NR base station according to an embodiment of the present disclosure;

FIG. 7 illustrates an operation and problems of the legacy NES CHO according to an embodiment of the present disclosure;

FIG. 8 illustrates a case of transmitting NES CHO configurations according to an embodiment of the present disclosure;

FIG. 9 illustrates a method by which a user equipment selects a final cell among candidate cells in accordance with the priority according to an embodiment of the present disclosure;

FIG. 10 illustrates a UE operation for Example 1 according to an embodiment of the present disclosure;

FIG. 11 illustrates a UE operation for Example 2 according to an embodiment of the present disclosure; and

FIG. 12 illustrates an operation of a serving base station according to an embodiment of the present disclosure.

### DETAILED DESCRIPTION

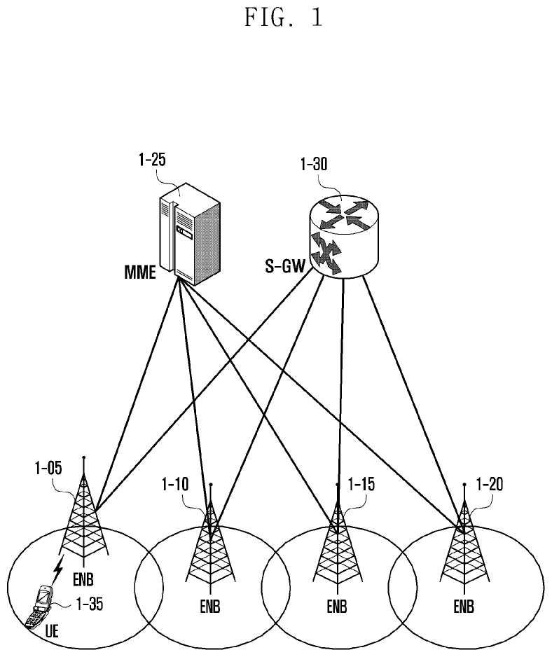

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The principles of operation of the present disclosure will now be described in detail with reference to the attached drawings. In the following description of the present disclosure, if a detailed description of a related known function or configuration is judged to unnecessarily obscure the essence of the present disclosure, the detailed description will be omitted. In addition, the terms described below are defined in consideration of the functions in the present disclosure and may vary depending on the intention or custom of the user or the operator. Therefore, the definitions should be taken in the context of the entire specification.

As used in the following description, terms for identifying access nodes, terms for referring to network entities, terms for referring to messages, terms for referring to interfaces between network entities, and terms for referring to various identifying information are exemplified for ease of explanation. Accordingly, the disclosure is not limited to the terms described herein, and other terms may be used to refer to objects having equivalent technical meaning.

Hereinafter, a base station is an entity that performs resource allocation for a user equipment, which may be at least one of gNode B, eNode B, Node B, a base station (BS), a wireless access unit (e.g., circuit), a base station controller, or a node on a network. A user equipment may include a user equipment (UE), a mobile station (MS), a cellular phone, a smartphone, a computer, or a multimedia system capable of performing communication functions. In the present disclosure, downlink (DL) refers to a wireless transmission path of a signal transmitted by a base station to a user equipment, and uplink (UL) refers to a wireless transmission path of a signal transmitted by a user equipment to a base station. In addition, while LTE or LTE-A systems may be described herein as an example, embodiments of the present disclosure may be applied to other communication systems having similar technical backgrounds or channel types. For example, fifth generation mobile communication technology (5G, new radio, NR) developed after LTE-A may be included as a system to which embodiments of the present disclosure may be applied, and 5G herein may be a concept that includes legacy LTE, LTE-A, and other similar services. In addition, the present disclosure may be applied to other communication systems with some modifications that do not substantially depart from the scope of the present disclosure as determined by a person skilled in the art. It will be understood that each block of the processing flowchart illustrations and combinations of the flowchart illustrations may be performed by computer program instructions.

These computer program instructions may be mounted on a processor of a general purpose computer, a special purpose computer, or other programmable data processing equipment, such that the instructions, when executed by the processor of the computer or other programmable data processing equipment, create means for performing the functions described in the flowchart block(s). These computer program instructions may be stored in computer-usable or computer-readable memory that may be directed to a computer or other programmable data processing equipment to implement the functions in a particular manner, so that the instructions stored in the computer-usable or computer-readable memory may produce a manufactured item comprising instructional means for performing the functions described in the flowchart block(s). The computer program instructions may also be mounted on a computer or other programmable data processing equipment and a series of operational steps are performed on the computer or other programmable data processing equipment to create a computer-executable process, such that the instructions performing the computer or other programmable data processing equipment may also provide steps for performing the functions described in the flowchart block(s).

In addition, each block may represent a module, a segment, or a portion of code comprising one or more executable instructions for performing a specified logical function(s). It should also be noted that in some alternative embodiments, the functions recited in the blocks may occur out of sequence. For example, two blocks shown one after the other may in fact be performed substantially simultaneously, or the blocks may be performed in reverse order according to the functions they sometimes perform. As used herein, the term “˜part” refers to software or a hardware component such as a field programmable gate array (FPGA) or application specific integrated circuit (ASIC), which may perform any of the roles. However, “˜part” is not software or hardware specific. It may be configured to reside on an addressable storage medium, or it may be configured to execute one or more processors. Therefore, in one example, “˜part” includes components such as software components, object-oriented software components, class components, and task components, processes, functions, properties, procedures, subroutines, segments of program code, drivers, firmware, microcode, circuits, data, databases, data structures, tables, arrays, and variables. The functionality provided within the components and “˜parts” may be combined into fewer components and “˜parts,” or further separated into additional components and “˜parts.” Furthermore, the components and “˜parts” may be implemented to play one or more CPUs within the device or the security multimedia card. Furthermore, in embodiments, the “˜part” may include one or more processors.

For the convenience of the following description, the present disclosure uses the terms and names defined in the 5GS and NR standards, which are standards defined by the 3GPP (The 3rd Generation Partnership Project) organization among currently existing communication standards. However, the present disclosure is not limited by these terms and names and may be equally applicable to wireless communication networks complying with other standards. For example, the present disclosure may be applied to 3GPP 5GS/NR (5th generation mobile communication standard).

FIG. 1 illustrates a structure of a general LTE system according to an embodiment of the present disclosure.

With reference to FIG. 1, as shown, the radio access network of an LTE system may be constituted of a next generation base station (Evolved Node B, hereinafter, referred to as ENB, Node B, or base station) 1-05, 1-10, 1-15, and 1-20, a Mobility Management Entity (MME) 1-25, and a Serving-Gateway (S-GW) 1-30. A user equipment (hereinafter, UE, or terminal) 1-35 may access the external network through ENBs 1-05 to 1-20 and S-GW 1-30.

In FIG. 1, eNB 1-05 to 1-20 may correspond to existing Node B of the UMTS system. The eNB may be connected to the UE 1-35 through a wireless channel and perform a more complex role than the existing Node B. In an LTE system, all user traffics, including real-time services such as voice over IP (VOIP) through the Internet Protocol, may be serviced through a shared channel. Therefore, a device is needed to perform scheduling by collecting status information such as a buffer status, an available transmission power status, and a channel status of UEs, and eNB 1-05 to 1-20 may be responsible for this. One eNB may typically control multiple cells. For example, to implement a transmission speed of 100 Mbps, the LTE system may use orthogonal frequency division multiplexing (OFDM) as a wireless access technology in, for example, a 20 MHz bandwidth. In addition, the adaptive modulation and coding (AMC) method, which determines the modulation scheme and the channel coding rate according to the channel status of the UE, may be applied. The S-GW (1-30) is a device that provides data bearers and may create or remove data bearers under the control of the MME (1-25). The MME may be connected to multiple base stations as a device that handles various control functions as well as mobility management functions for the UE.

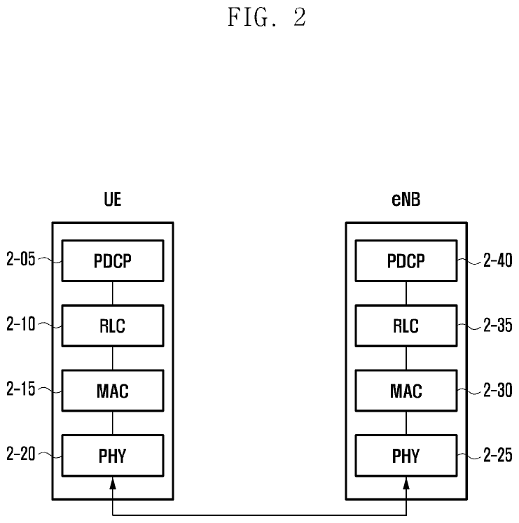

FIG. 2 illustrates a wireless protocol structure of the legacy LTE system according to an embodiment of the present disclosure.

With reference to FIG. 2, the wireless protocols of an LTE system may consist of Packet Data Convergence Protocol (PDCP) 2-05 and 2-40, Radio Link Control (RLC) 2-10 and 2-35, and Medium Access Control (MAC) 2-15 and 2-30 at the UE and ENB, respectively. PDCP may be responsible for operations such as IP header compression/restoration. The main functions of PDCP may be summarized as follows:
Header compression and decompression: ROHC only;
Transfer of user data;
In-sequence delivery of upper layer PDUs at PDCP re-establishment procedure for RLC AM;
For split bearers in DC (only support for RLC AM): PDCP PDU routing for transmission and PDCP PDU reordering for reception;
Duplicate detection of lower layer SDUs at PDCP re-establishment procedure for RLC AM;
Retransmission of PDCP SDUs at handover and, for split bearers in DC, of PDCP PDUs at PDCP data-recovery procedure, for RLC AM;
Ciphering and deciphering; and/or
Timer-based SDU discard in uplink.

Radio link control (RLC) 2-10 and 2-35 may reconfigure PDCP packet data units (PDUs) to the appropriate size and perform ARQ operations, etc. The main functions of the RLC may be summarized as follows:
Transfer of upper layer PDUs;
Error correction through ARQ (only for AM data transfer);
Concatenation, segmentation, and reassembly of RLC SDUs (only for UM and AM data transfer);
Re-segmentation of RLC data PDUs (only for AM data transfer);
Reordering of RLC data PDUs (only for UM and AM data transfer);
Duplicate detection (only for UM and AM data transfer);
Protocol error detection (only for AM data transfer);
RLC SDU discard (only for UM and AM data transfer); and/or
RLC re-establishment.

The MAC 2-15 and 2-30 may be connected to multiple RLC layer devices configured in a UE and perform multiplexing of RLC PDUs into MAC PDUs and demultiplexing of RLC PDUs from MAC PDUs. The main functions of the MAC may be summarized as follows:
Mapping between logical channels and transport channels;
Multiplexing/demultiplexing of MAC SDUs belonging to one or different logical channels into/from transport blocks (TB) delivered to/from the physical layer on transport channels;
Scheduling information reporting;
Error correction through HARQ;
Priority handling between logical channels of one UE;
Priority handling between UEs by means of dynamic scheduling;
MBMS service identification;
Transport format selection; and/or
Padding function.

The physical layer 2-20 and 2-25 may perform the operations of channel-coding and modulating the upper layer data into OFDM symbols and transmitting through the wireless channel, or demodulating and channel-decoding the OFDM symbols received through the wireless channel and delivering them to the upper layer.

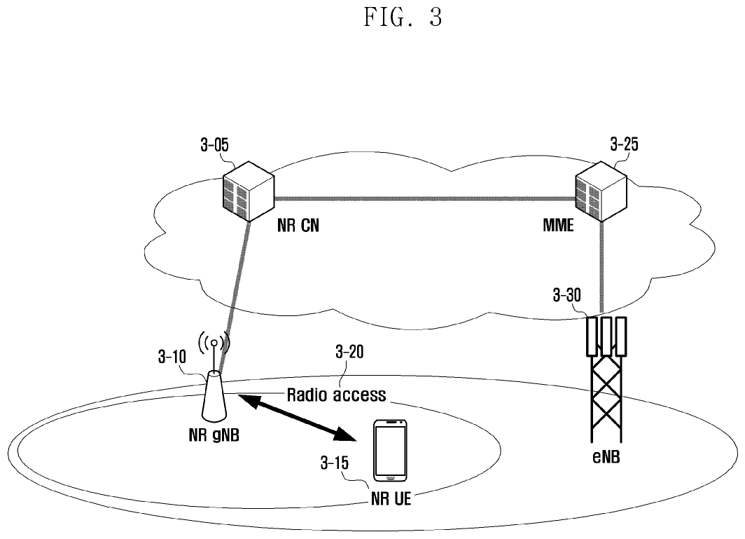

FIG. 3 illustrates a structure of a next generation mobile communication system according to an embodiment of the present disclosure.

With reference to FIG. 3, a radio access network of a next generation mobile communication system (hereinafter referred to as NR or 5G) may be constituted of a new radio Node B (hereinafter referred to as NR gNB or NR base station) 3-10 and a new radio core network (NR CN) 3-05. The new radio user equipment (NR UE or terminal) 3-15 may access the external network through the NR gNB 3-10 and the NR CN 3-05.

In FIG. 3, the NR gNB 3-10 may correspond to an evolved Node B (eNB) of the legacy LTE system. The NR gNB may be connected to the NR UE 3-15 by a wireless channel and provide a far better service than the existing Node B. In next-generation mobile communication systems, all user traffic may be served through a shared channel. Therefore, a device that aggregates status information such as buffer status of UEs, available transmission power status, channel status, etc. and performs scheduling is required and the scheduling may be performed by NR NB 3-10. One NR gNB may control multiple cells. In next-generation mobile communication systems, bandwidths beyond the typical maximum bandwidth may be applied to realize ultra-high speed data transmission compared to the general LTE. In addition, the beamforming technology may be additionally applied using orthogonal frequency division multiplexing (OFDM) as a wireless access technology. In addition, the adaptive modulation and coding (AMC) method, which determines the modulation scheme and channel coding rate according to the channel condition of the UE, may be applied. The NR CN 3-05 may perform functions such as mobility support, bearer configuration, and QoS configuration. The NR CN may be connected to the multiple base stations as a device responsible for various control functions as well as mobility management functions for the UE. In addition, the next-generation mobile communication system may also be interworked with the LTE system, and the NR CN may be connected to the MME 3-25 through a network interface. The MME may be connected to an LTE base station, the eNB 3-30.

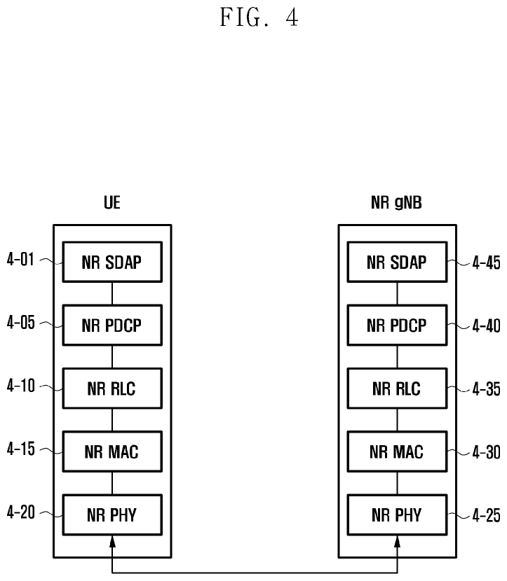

FIG. 4 illustrates a wireless protocol structure of a next generation mobile communication system according to an embodiment of the present disclosure.

With reference to FIG. 4, the wireless protocols of a next-generation mobile communication system consist of NR service data adaptation protocol (SDAP) 4-01 and 4-45, NR PDCP 4-05 and 4-40, NR RLC 4-10 and 4-35, NR MAC 4-15 and 4-30, and NR PHY 4-20 and 4-25 at the UE and the NR base station, respectively.

The main functions of NR SDAP 4-01 and 4-45 may include some of the following functions:
Transfer of user plane data;
Mapping between a QoS flow and a DRB for both DL and UL;
Marking QoS flow ID in both DL and UL packets for uplink and downlink; and/or
Reflective QoS flow to DRB mapping for the UL SDAP PDUs.

For SDAP layer devices, the UE may be configured by a radio resource control (RRC) message whether to use the SDAP layer device header or the functions of the SDAP layer device on a PDCP layer device level, a bearer level, or a logical channel level. If the SDAP header is used, the UE may use the non-access stratum (NAS) quality of service (QoS) reflective setting 1-bit indicator (NAS reflective QoS) and the access stratum (AS) QoS reflective setting 1-bit indicator (AS reflective QoS) in the SDAP header to instruct the UE to update or reconfigure the QoS flows and mapping information for uplink and downlink data bearers. The SDAP header may include QoS flow ID information indicating the QoS. Qos information may be used as data processing priorities, scheduling information, etc. to support seamless service.

The main functions of NR PDCP 4-05 and 4-40 may include some of the following functions:
Header compression and decompression (ROHC only);
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

In the above description, the reordering function of the NR PDCP device may mean the function of reordering PDCP PDUs received from the lower layer based on PDCP sequence numbers (SN). The reordering function of the NR PDCP device may include a function of delivering the data to the upper layer in the reordered order or a function of delivering the data directly without considering the order, may include a function of recording the lost PDCP PDUs after rearranging the order, may include a function of reporting the status of the lost PDCP PDUs to the transmitting side, and may include a function of requesting retransmission of the lost PDCP PDUs.

The main functions of NR RLC 4-10 and 4-35 may include some of the following functions:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection function;
Protocol error detection;
RLC SDU discard; and/or
RLC re-establishment.

In the above description, the in-sequence delivery function of the NR RLC device may mean the function of delivering RLC SDUs received from the lower layer to the higher layer in order. In the case that one RLC SDU is originally received by being divided into multiple RLC SDUs, the in-sequence delivery function of the NR RLC device may include the function of reassembling and delivering it.

The in-sequence delivery function of the NR RLC device may include a function to rearrange the received RLC PDUs based on the RLC sequence number (SN) or PDCP SN, may include a function of recording the lost RLC PDUs after rearranging the order, may include a function of reporting the status of the lost RLC PDUs to the transmitting side, and may include a function of requesting retransmission of the lost RLC PDUs.

The in-sequence delivery function of the NR RLC device may include a function of delivering only the RLC SDUs to the upper layer in order up to the lost RLC SDU when there is a lost RLC SDU.

The in-sequence delivery function of the NR RLC device may include a function of delivering all RLC SDUs received before the timer starts to the upper layer in order if a predetermined timer expires even if there are lost RLC SDUs.

The in-sequence delivery function of the NR RLC device may include a function of delivering all RLC SDUs received to date to the upper layer in order if a predetermined timer expires even if there are lost RLC SDUs.

The NR RLC device may process RLC PDUs in the order they are received and deliver them to the NR PDCP device, regardless of the order of the sequence number (out-of-sequence delivery).

In the case that the NR RLC device receives a segment, the device may receive segments stored in a buffer or to be received later, reconstruct them into one complete RLC PDU, and then transmit the RLC PDU to the NR PDCP device.

The NR RLC layer may not include a concatenation function, and may perform the function in the NR MAC layer or replace the concatenation function with the multiplexing function of the NR MAC layer.

In the above description, the out-of-sequence delivery function of the NR RLC device may refer to the function of directly delivering RLC SDUs received from a lower layer to the upper layer regardless of their order. The out-of-sequence delivery function of the NR RLC device may include a function of reassembling and delivering when one RLC SDU is originally received by being divided into several RLC SDUs. The out-of-sequence delivery function of the NR RLC device may include a function of storing the RLC SN or PDCP SN of received RLC PDUs, sorting the order, and recording lost RLC PDUs.

The NR MAC 4-15 and 4-30 may be connected to multiple NR RLC layer devices configured in one UE, and the main functions of NR MAC may include some of the following functions:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

The NR PHY layer 4-20 and 4-25 may perform the operations of channel-coding and modulating the upper layer data into OFDM symbols and transmitting through the wireless channel, or demodulating and channel-decoding the OFDM symbols received through the wireless channel and delivering them to the upper layer.

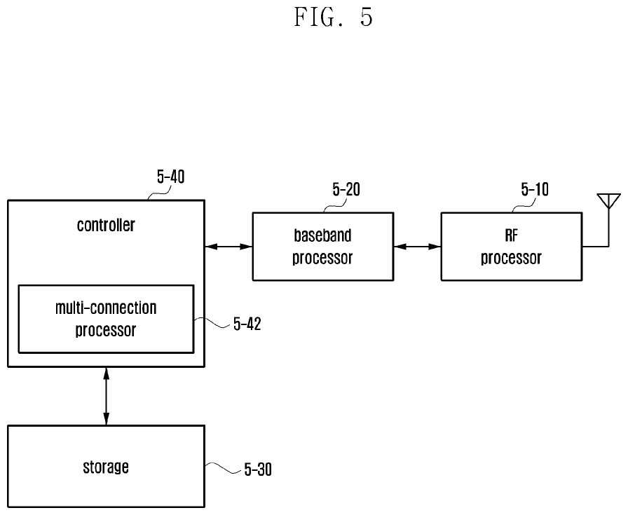

FIG. 5 illustrates a structure of a UE according to an embodiment of the present disclosure.

With reference to the drawing, the UE includes a Radio Frequency (RF) processor 5-10, a baseband processor 5-20, a storage 5-30, and a controller 5-40.

The RF processor 5-10 performs functions for transmitting and receiving signals through a wireless channel, such as band conversion and amplification of signals. The RF processor 5-10 upconverts a baseband signal provided from the baseband processor 5-20 into an RF band signal and transmits the RF band signal through an antenna, and downconverts the RF band signal received through the antenna into a baseband signal. For example, the RF processor 5-10 may include a transmitting filter, a receiving filter, an amplifier, a mixer, an oscillator, a digital to analog converter (DAC), an analog to digital converter (ADC), etc. In the drawing, only one antenna is shown, but the UE may have multiple antennas. In addition, the RF processor 5-10 may include multiple RF chains. Furthermore, the RF processor 5-10 may perform beamforming. For the beamforming, the RF processor 5-10 may adjust the phase and magnitude of each of the signals transmitted and received through the plurality of antennas or antenna elements. Furthermore, the RF processor may perform MIMO, and may receive multiple layers when performing MIMO operation.

The baseband processor 5-20 performs a conversion function between baseband signals and bitstreams according to the physical layer standard of the system. For example, when transmitting data, the baseband processor 5-20 generates complex symbols by encoding and modulating the transmitted bitstream. Also, when receiving data, the baseband processor 5-20 restores the received bitstream by demodulating and decoding the baseband signal provided from the RF processor 6-10. For example, when transmitting data according to the orthogonal frequency division multiplexing (OFDM) method, the baseband processor 5-20 generates complex symbols by encoding and modulating the transmitted bitstream, maps the complex symbols to subcarriers, and constructs the OFDM symbols through an inverse fast Fourier transform (IFFT) operation and a cyclic prefix (CP) insertion. In addition, when receiving data, the baseband processor 5-20 divides the baseband signal provided from the RF processor 5-10 into OFDM symbol units and restores the received bitstream through demodulating and decoding after restoring signals mapped to subcarriers through FFT operation.

The baseband processor 5-20 and the RF processor 5-10 transmit and receive signals as described above. Accordingly, the baseband processor 5-20 and the RF processor 5-10 may be referred to as a transmitting circuit, a receiving circuit, a transceiver, or a communication circuit. Furthermore, at least one of the baseband processor 5-20 and the RF processor 5-10 may include multiple communication modules to support multiple different wireless access technologies. Furthermore, at least one of the baseband processor 5-20 and the RF processor 5-10 may include different communication modules to process signals in different frequency bands. For example, the different wireless access technologies may include wireless LAN (e.g., IEEE 802.11), cellular networks (e.g., LTE), etc. Furthermore, the different frequency bands may include super high frequency (SHF) (e.g., 2.NRHz, NRhz) bands, millimeter wave (mm Wave) (e.g., 60 GHz) bands, etc.

The storage 5-30 stores data such as basic programs, application programs, configuration information, etc. for the operation of the UE. In particular, the storage 5-30 may store information related to a second connection node performing wireless communication using a second wireless connection technology. In addition, the storage 5-30 provides the stored data upon request of the controller 5-40.

The controller 5-40 controls overall operations of the UE. For example, the controller 5-40 transmits and receives signals through the baseband processor 5-20 and the RF processor 5-10. In addition, the controller 5-40 writes and reads data into the storage 5-30. For this purpose, the controller 5-40 may include at least one processor. For example, the controller 5-40 may include a communication processor (CP) that performs control for communication and an application processor (AP) that controls upper layers such as application programs.

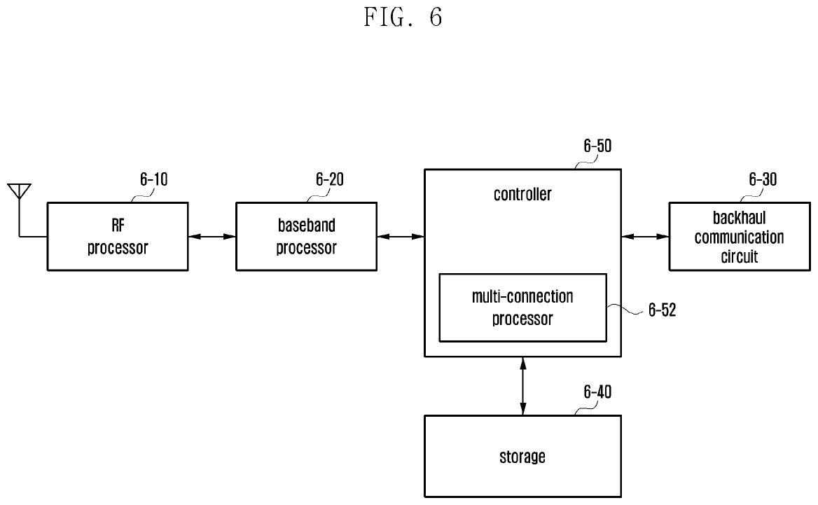

FIG. 6 illustrates a configuration of an NR base station according to an embodiment of the present disclosure.

As shown in the drawing, the base station is constituted to include an RF processor 6-10, a baseband processor 6-20, a backhaul communication unit 6-30, a storage 6-40, and a controller 6-50.

The RF processor 6-10 performs functions for transmitting and receiving signals through a wireless channel, such as band conversion and amplification of signals. The RF processor 6-10 upconverts a baseband signal provided from the baseband processor 6-20 into an RF band signal and transmits the RF band signal through an antenna, and downconverts the RF band signal received through the antenna into a baseband signal. For example, the RF processor 6-10 may include a transmission filter, a receiving filter, an amplifier, a mixer, an oscillator, a DAC, an ADC, etc. In the drawing, only one antenna is shown, but the first connection node may be equipped with multiple antennas. In addition, the RF processor 6-10 may include multiple RF chains. Furthermore, the RF processor 6-10 may perform beamforming. For the beamforming, the RF processor 6-10 may adjust the phase and magnitude of each of signals transmitted and received through multiple antennas or antenna elements. The RF processor may perform downlink MIMO operation by transmitting one or more layers.

The baseband processor 6-20 performs a conversion function between baseband signals and bitstreams according to the physical layer standard of the first wireless access technology. For example, when transmitting data, the baseband processor 6-20 generates complex symbols by encoding and modulating the transmission bitstream. In addition, when receiving data, the baseband processor 6-20 restores the received bitstream by demodulating and decoding the baseband signal provided from the RF processor 6-10. For example, when transmitting data according to the OFDM method, the baseband processor 6-20 generates complex symbols by encoding and modulating the transmission bitstream, maps the complex symbols to subcarriers, and constructs OFDM symbols through IFFT operation and CP insertion. In addition, when receiving data, the baseband processor 6-20 divides the baseband signal provided from the RF processor 6-10 into OFDM symbol units and restores the received bitstream through demodulating and decoding after restoring signals mapped to subcarriers through FFT operation. The baseband processor 6-20 and the RF processor 6-10 transmit and receive signals as described above. Accordingly, the baseband processor 6-20 and the RF processor 6-10 may be referred to as a transmitting circuit, a receiving circuit, a transceiver, a communication circuit, or a wireless communication circuit.

The backhaul communication circuit 6-30 provides an interface for communicating with other nodes in the network. The backhaul communication circuit 6-30 converts a bitstream transmitted from the main base station to another node, for example, an auxiliary base station, a core network, etc., into a physical signal, and converts the physical signal received from the other node into a bitstream.

The storage 6-40 stores data such as basic programs, application programs, and configuration information for operation of the main base station. In particular, the storage 6-40 may store information about bearers assigned to the connected UE, measurement results reported from the connected UE, etc. In addition, the storage 6-40 may store information that serves as a criterion for determining whether to provide or suspend multiple connections to the UE. In addition, the storage 6-40 provides stored data upon request from the controller 6-50.

The controller 6-50 controls overall operations of the base station. For example, the controller 6-50 transmits and receives signals through the baseband processor 6-20 and the RF processor 6-10, or through the backhaul communication circuit 6-30. In addition, the controller 6-50 writes and reads data into the storage 6-40. For this purpose, the controller 6-50 may include at least one processor.

A network energy saving (NES) operation of a cell may vary, but a typical example may be stopping synchronization signal block (SSB) transmission. In addition, it may be stopping transmitting system information including physical broadcast channel (PBCH). Along with this, it may include stopping of transmitting DL control and data channels, and/or stopping of receiving UL control/data channels. In any situation, the turn-off indication referred to in the present document is defined as a signal transmitted when the network wants to move the UE to a specific cell.

(Example 1) The network may provide configurations for NES CHO to each UE in a connected mode through a serving cell.
The configurations for the NES conditional handover (CHO) may be transmitted in a separate field from the configurations for the general CHO.
   The information in the configurations for the NES CHO may include the following.
      The configuration to be used in the target cell, in one embodiment, may be the RRCReconfiguration message created in the node of the target cell. Or it may be CellGroupConfiguration.
      As condition information for handover to the target cell, it may be a pair of a specific measurement Object and report Config, or a measurement ID indicating the pair. This measurement ID may be multiple.
         The measurement ID may refer to specific ID(s) configured on the measurement configuration configured in the cell group that includes the corresponding serving cell.
      A timer value notifying the start of handover to the target cell may be included. The timer may mean a predetermined absolute time value, or it may mean a specific relative value from the time the NES CHO configurations are received. The UE that receives this timer value may be considered that NES CHO is triggered when the absolute time expires (if receiving an absolute time value) or the transmitted value expires after starting the timer at the time when NES CHO configuration is received. Afterwards, the condition may be evaluated, or if the evaluation has been completed, NES CHO may be performed on one of the cells that satisfy the condition.
      The NES CHO configuration information for the specific target cell, that is, target cell configuration information, condition information, and timer information, may be bundled into one and delivered with an assigned ID. This ID may have a separate ID value from the condReconfig ID used in general CHO.
   The UE that has received the configuration information for NES CHO may store the information in a separate UE variable. In addition, the network may add new ID information based on the ID value among the above information and deliver modified configuration information about the ID values that the UE had. Alternatively, a specific ID may be designated from the UE and information on that ID may be removed.
   The UE that has received the configuration information for NES CHO may perform one of the following operations.
      Case 1) The UE may perform measurement for the measurement ID given as a condition among the configuration information. In addition, evaluation of conditions linked to the corresponding measurement ID may be performed. Afterwards, if the network transmits a turn-off indicator or NES CHO is triggered by a timer value included in the configuration information, NES CHO may be performed.
      Case 2) The UE may perform measurement for the measurement ID given as a condition among the configuration information. Afterwards, if the network transmits a turn-off indicator or NES CHO is triggered by the timer value included in the configuration information, then the condition linked to the measurement ID may be evaluated and NES CHO execution may begin.
      Case 3) The UE does not take any special action when receiving configuration information. Afterwards, if the network transmits a turn-off indicator or NES CHO is triggered by the timer value included in the configuration information, then measurement may be performed on the measurement ID, evaluation of the associated conditions may be performed, and NES CHO may be started.
   After performing when receiving the above configuration information, NES CHO may be proceeded to be performed. At this time, the performance of NES CHO may be defined as follows.
      According to the condition evaluation, if there is a cell that satisfies the condition among the candidate cells, NES CHO is performed on that cell. If there are no candidate cells that satisfy the condition according to the condition evaluation, condition evaluation continues until a cell that satisfies the condition is found, and if a cell that satisfies the condition is found, NES CHO is performed on the cell.
         If there are multiple candidate cells that satisfy the NES CHO condition, the UE may select one of them.
      Performing the NES CHO may be an operation in which the UE applies the target cell configuration information of the NES CHO.
   In this method, NES CHO candidate cells and general CHO candidate cells may be the same. And for one candidate cell, the configurations of the NES CHO candidate cell and the configurations of the general CHO candidate cell may be the same or different.
The configurations for the NES CHO may be transmitted by being included in a field containing the configurations for the general CHO. For example, the CondReconfigToAddMod field containing specific candidate target cell configuration information may include an indicator for NES CHO.
   In this case, the configuration information of the target cell of NES CHO and the configuration information ID of NES CHO are all the same as the configuration information and ID of the target cell of general CHO.
   The UE may store the NES CHO configuration information in UE variables used for general CHO. The network may request the UE to add/change or remove configuration information using the same ID.
   In addition, information referring to the conditions of the corresponding NES CHO may be additionally included in connection with the indicator. If this information is not present, the UE recognizes the condition information among the general CHO configuration information including this indicator as the condition information for the target cell of the NES CHO.
      As condition information for handover to the target cell, it may be a pair of a specific measurement Object and report Config, or a measurement ID indicating the pair. This measurement ID may be multiple.
         The measurement ID may refer to specific ID(s) configured on the measurement configuration configured in the cell group that includes the corresponding serving cell.
   The UE that has received the configuration information for NES CHO may perform one of the following operations.
      Case 1) The UE may perform measurement for the measurement ID given as a condition among the configuration information. Afterwards, if the network transmits a turn-off indicator or NES CHO is triggered by the timer value included in the configuration information, then the condition linked to the measurement ID may be evaluated and NES CHO execution may begin.
      Case 2) The UE may perform measurement for the measurement ID given as a condition among the configuration information. In addition, evaluation of conditions linked to the corresponding measurement ID may be performed. Afterwards, if the network transmits a turn-off indicator or NES CHO is triggered by a timer value included in the configuration information, NES CHO may be performed.
   After performing when receiving the above configuration information, NES CHO may be proceeded to be performed. At this time, the performance of NES CHO may be defined as follows.
      According to the condition evaluation, if there is a cell that satisfies the condition among the candidate cells, NES CHO is performed on that cell. If there are no candidate cells that satisfy the condition according to the condition evaluation, condition evaluation continues until a cell that satisfies the condition is found, and if a cell that satisfies the condition is found, NES CHO is performed on the cell.
         If there are multiple candidate cells that satisfy the NES CHO condition, the UE may select one of them.
      Performing the NES CHO may be an operation in which the UE applies the target cell configuration information of the NES CHO.

(Example 2) When performing NES CHO, if multiple candidate cells satisfy the conditions, the UE may select the target cell by applying the priority received from the network when selecting one of the candidate cells.
For the above operation, the network may transmit to the UE including one priority value in connection with the candidate cell configuration information of each NES CHO.
   The operation may be performed together with or independently of the network signaling method, that is, the method of the embodiment 1.
      After receiving the NES CHO configuration information of the embodiment 1 from the network, the UE may perform UE operations upon reception and operations after NES CHO is triggered. Afterwards, if there are multiple candidate cells that satisfy the condition, the UE may perform NES CHO by selecting the cell with the highest priority among the candidate cells.
   The above operation may be performed regardless of the configuration information of general CHO or NES CHO.
      In this case, the network may transmit to the UE including the priority value associated with each candidate cell configuration information regardless of the general CHO or NES CHO configuration method.
      After NES CHO is triggered, if there are multiple candidate cells that satisfy the conditions, the UE may select the candidate cell with the highest priority among the cells as the target cell and perform NES CHO.

Among the above operations, if general CHO and NES CHO are configured at the same time, and if the conditions of general CHO and NES CHO are satisfied at the same time, the UE may consider only one of the two CHOs and select and perform one target cell out of them.
If a priority is given to each cell, the cell with the highest priority may be selected and the configuration information of the cell may be applied.
If the priority is not defined,
   the UE may randomly select one of the NES CHO candidate cells that satisfies the conditions and perform the NES CHO with that cell.
   Alternatively, the UE may randomly select one of the general CHO candidate cells that satisfies the conditions and perform the general CHO with that cell.

As a method of improving NES CHO itself, rather than from the above load balancing perspective, the following method may be considered.
If the UE includes information indicating its NES CHO support in the UECapabilityInformation message to the serving base station, or does not include an indicator that the UE supports the cell's network energy saving operation, the network may configure NES CHO to the UE.
When the UE transmits to the serving base station, through UEAssistanceInformation, an indicator indicating that the UE prefers the NES operation of the cell, the network may configure NES CHO to the UE.
Even a UE that has received the NES CHO configuration and has received a turn-off instruction may not perform HO if the UE is receiving only delay tolerant service in its service state and if such an indicator is included in the turn-off instruction.

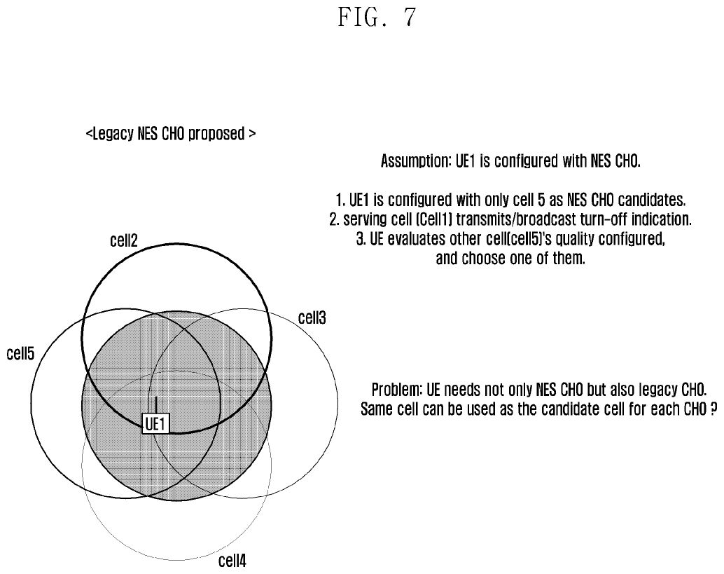

FIG. 7 illustrates an operation and problems of the legacy NES CHO according to an embodiment of the present disclosure.

If only the legacy NES CHO is applied to the cell and the network transmits only candidate cells considering load balancing to the UE through the NES CHO configuration, the UE may perform a handover only to one of the candidate cells. However, if the general CHO is also allowed, it may vary depending on whether the candidate cell for the same UE is for NES or general CHO. The general CHO may make replacement cells to cope with problem situations in the serving cell, as candidate cells and may configure a relatively large number of candidate cells. However, as the NES CHO is in a situation where not only a cell with a signal strength being not bad, but also multiple UEs are performing a handover operation to other cells at the same time, a load balancing is necessary to prevent multiple UEs from gathering in a specific cell. The candidate cells that take such load balancing into consideration configure the UE to a smaller number of candidate cells than the general CHO, and the serving cell may make a comprehensive judgment based on the information after receiving the measurement results of all other NES CHOs and information on the current load status of the base station and the cell from the base station that manages the candidate cells.

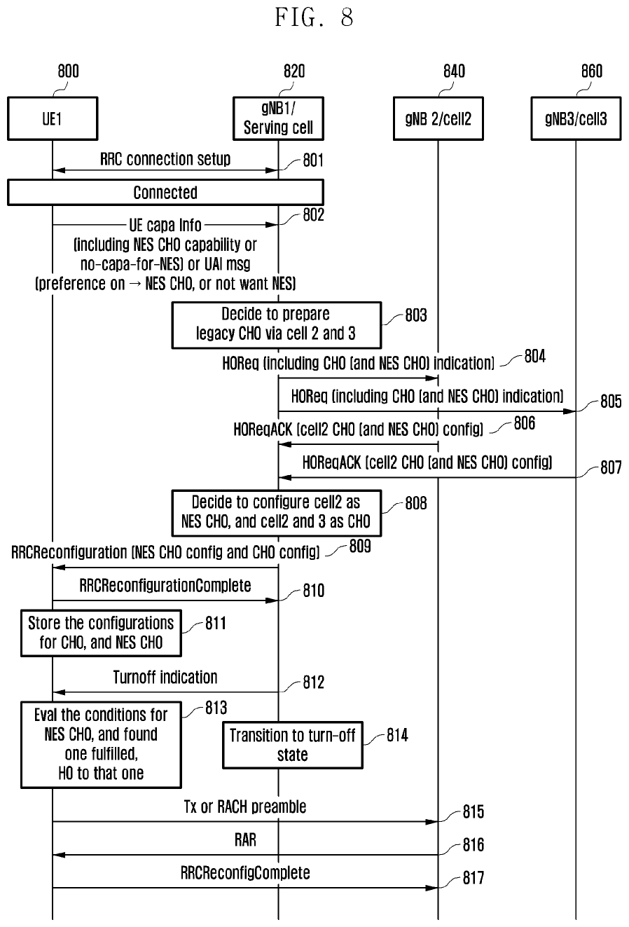

FIG. 8 illustrates a case of transmitting NES CHO configurations according to an embodiment of the present disclosure.

With reference to FIG. 8, this is an example of a case where the network transmits NES CHO configurations in a separate field.

The UE1 800 may send an RRC connection setup message to the serving base station 820 (step 801). The UE1 800 may enter connection mode with the serving base station 820, and may then forward a UE capability information message to the serving base station 820 including an indicator/field indicating support for NES CHO functionality or an indicator/field indicating no support for NES operation in the cell (step 802).

Alternatively, the UE may transmit the UEAssistanceInformation message to the serving base station 820, including an indicator that the UE prefers NES CHO or does not prefer the NES operation of the cell.

The serving base station 820 that has acquired the information may decide to configure a general CHO (step 803). Afterwards, the candidate cells may be determined and HOReq messages may be sent to base stations 840 and 860 in those cells (step 804 and step 805). At this point, if the NES CHO is desired to be configured together, the HOReq message may include a NES CHO indicator as well as a general CHO indicator.

The base stations 840 and 860 of the candidate cell receive the HOReq message and perform an admission control of the target cell. As a result, the HOReqACK message may include the configuration information (RRCReconfiguration or CellGroupConfig) of the corresponding target cell and be forwarded to the serving (source) gNB 820 (step 806 and step 807).

The source base station 820 that has received the message may add conditional information about the candidate cells of the general CHO, add an ID, include the information in the conditionalReconfiguration field of the RRCReconfiguration message, and deliver the information to the UE 800 (step 809). At this point, the serving base station 820 may additionally determine the candidate cells for the NES CHO (step 808). That is, the serving base station 820 may determine that only a subset of the cells allowed as general CHOs, or a separate subset of cells through the transmission of a separate HOReq message/receipt of a HOReqACK message, are candidate cells for the NES CHO. The serving base station 820 may include the configuration information of the determined NES CHO candidate cells (the configuration information of the target cell, the condition information associated with the cell, the timer information to be used when triggering the NES CHO, and the ID information associated with the configuration of each candidate cell) in the RRCReconfiguration message and deliver the information together to the UE 800 (step 809). In this case, the configuration information of the NES CHO may be included in a separate field other than the conditionalReconfiguration field of the general CHO.

The UE 800 that receives the RRCReconfiguration message may transmit an RRCReconfigurationComplete message to the serving base station 820 (step 811).

The UE 800 that receives the RRCReconfiguration message may store each condition (step 811). Measurement of each condition and determination of the condition may be started.

Thereafter, a turn-off indication may be transmitted from the serving cell 820 of the serving base station to the UE 800 (step 812). The UE 800 that receives the turn-off indication may determine which of the candidate cells for the NES CHO satisfy the conditions, select one of the cells, and perform the NES CHO with that cell (step 813).

Thereafter, a random access procedure satisfying the conditions may be performed (step 815 to step 817).

The drawing shows only UE1, but multiple UEs may perform the operation.

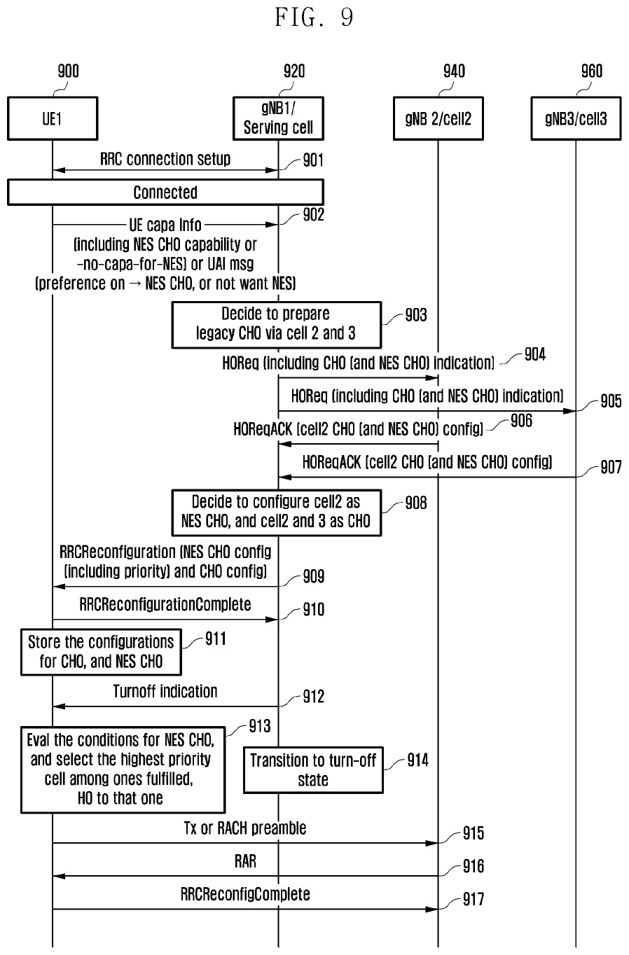

FIG. 9 illustrates a method by which a UE selects a final cell among candidate cells in accordance with the priority according to an embodiment of the present disclosure.

Steps similar to those in FIG. 8 are first performed.

The UE1 900 may send an RRC connection setup message to the serving base station 920 (step 901). The UE1 900 may enter connection mode with the serving base station 920, and may then forward a UE capability information message to the serving base station 920, including an indicator/field indicating support for NES CHO functionality or an indicator/field indicating no support for NES operation in the cell (step 902).

Alternatively, the UE may transmit the UEAssistanceInformation message to the serving base station, including an indicator that the UE prefers NES CHO or does not prefer the NES operation of the cell.

The serving base station that acquired the information may decide to configure a general CHO (step 903). Afterwards, the candidate cells may be determined and HOReq messages may be sent to the base stations 940 and 960 in those cells (step 904 and step 905). At this point, if the NES CHO is desired to be configured together, the HOReq message may include a NES CHO indicator as well as a general CHO indicator.

The base stations 940 and 960 of the candidate cell receive the HOReq message and perform an admission control of the target cell. As a result, the HOReqACK message may include the configuration information (RRCReconfiguration or CellGroupConfig) of the corresponding target cell and be forwarded to the serving (source) gNB 920 (step 906 and step 907).

The source base station 920 that has received the message may add conditional information about the candidate cells of the general CHO, add an ID, include the information in the conditionalReconfiguration field of the RRCReconfiguration message, and deliver the information to the UE 900 (step 909). At this point, the serving base station 920 may additionally determine the candidate cells for the NES CHO (step 908). That is, the serving base station 920 may determine that only a subset of the cells allowed as general CHOs, or a separate subset of cells through the transmission of a separate HOReq message/receipt of a HOReqACK message, are candidate cells for the NES CHO. The serving base station 920 may include the configuration information of the determined NES CHO candidate cells (the configuration information of the target cell, the condition information associated with the cell, the timer information to be used when triggering the NES CHO, the ID information associated with the configuration of each candidate cell, and the priority value of each candidate cell) in the RRCReconfiguration message and deliver the information together to the UE 900 (step 909). In this case, the configuration information of the NES CHO may be included in a separate field other than the conditionalReconfiguration field of the general CHO. The UE 900 that has received the RRCReconfiguration message may transmit an RRCReconfigurationComplete message to the serving base station 920 (step 911).

The UE 900 that receives the RRCReconfiguration message may store each condition (step 910). Measurement of each condition and determination of the condition may be started.

Thereafter, a turn-off indication may be transmitted from the serving cell 920 of the serving base station to the UE 900 (step 912). The UE 900 that receives the turn-off indication may determine which of the candidate cells for NES CHO satisfy the condition, and if multiple cells satisfy the condition, the UE 900 may select the cell with the highest priority among the priority values communicated in the previous configuration and perform NES CHO with that cell. If there is only one cell that satisfies the condition, the NES CHO can be performed with that cell (step 913).

Thereafter, a random access procedure satisfying the condition may be performed (step 915 to step 917).

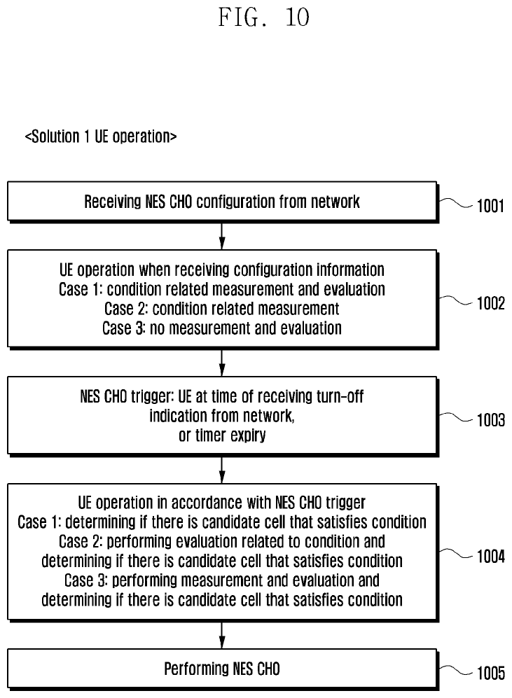

FIG. 10 illustrates a UE operation for example 1 of an embodiment of the present disclosure.

The UE may receive the NES CHO configuration from the serving base station (step 1001). The UE may then perform one of the operations mentioned above in cases 1, 2, and 3 (step 1002). (case 1: condition related measurement and evaluation, case 2: condition related measurement, case 3: no measurement and evaluation).

Thereafter, if the serving cell transmits a turn-off indication or the timer configured inside the UE expires (step 1003), the UE may perform the operation corresponding to cases 1, 2, and 3 when NES CHO is triggered (step 1004). (case 1: determining if there is a candidate cell that satisfies the condition, case 2: performing evaluation related to the condition and determining if there is a candidate cell that satisfies the condition, case 3: performing measurement and evaluation and determining if there is a candidate cell that satisfies the condition).

Afterwards, NES CHO is performed on one of the candidate cells (step 1005).

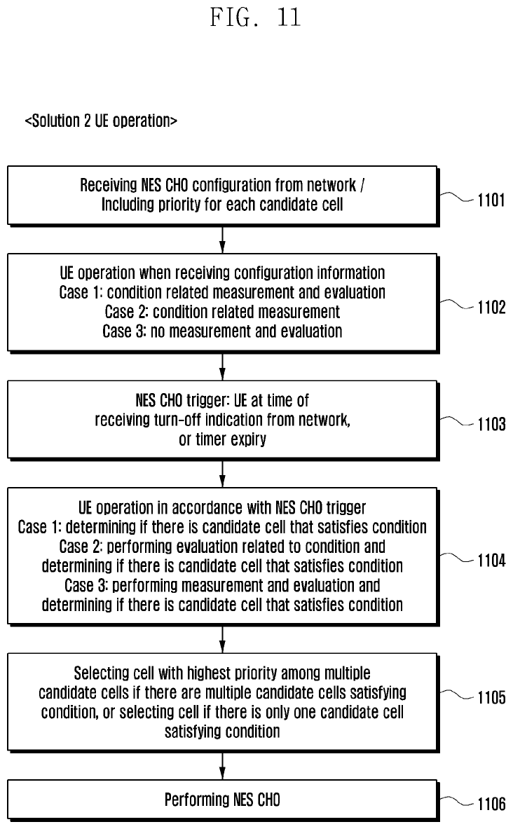

FIG. 11 illustrates a UE operation for example 2 of an embodiment of the present disclosure.

The UE receives the NES CHO configuration from the serving base station (step 1101). At this time, it may be transmitted including a priority value for each candidate cell. Upon receiving the configuration, the UE may perform one of the operations mentioned above in cases 1, 2, and 3 (step 1102). (case 1: condition related measurement and evaluation, case 2: condition related measurement, case 3: No measurement and evaluation).

Thereafter, if the serving cell transmits a turn-off indication or the timer configured inside the UE expires (step 1103), the UE may perform the operation corresponding to cases 1, 2, and 3 when NES CHO is triggered (step 1104). (case 1: determining if there is a candidate cell that satisfies the condition, case 2: performing evaluation related to the condition and determining if there is a candidate cell that satisfies the condition, case 3: performing measurement and evaluation and determining if there is a candidate cell that satisfies the condition).

Thereafter, if there are multiple candidate cells satisfying the condition, the device may select the cell with the highest associated priority for NES CHO, or if there is only one candidate cell satisfying the condition, the UE may select a single cell for NES CHO (step 1105). The NES CHO may be performed with the selected cell (step 1106).

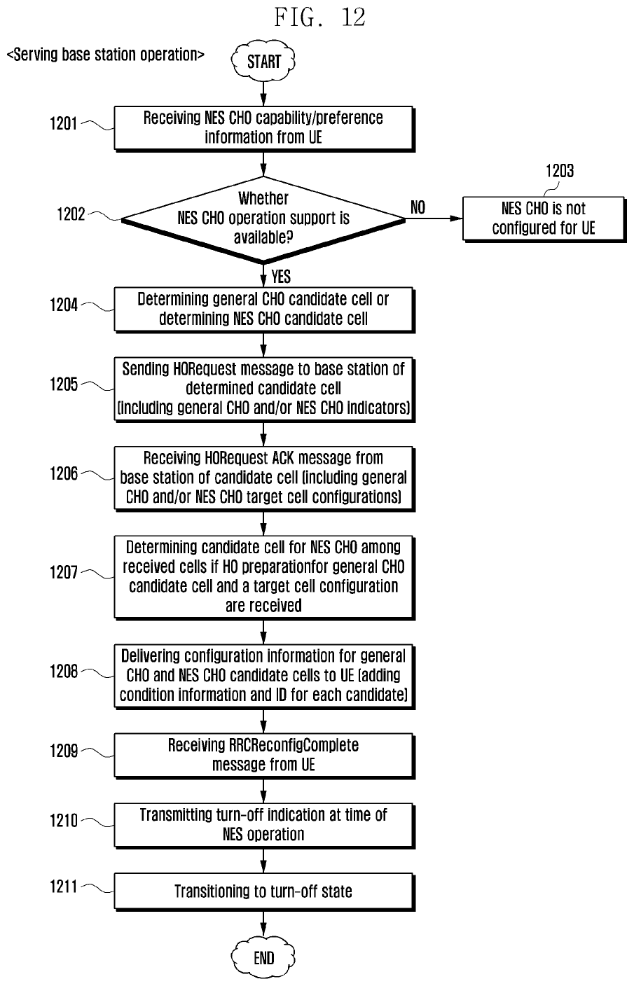

FIG. 12 illustrates an operation of a serving base station according to an embodiment of the present disclosure.

The serving base station may receive an indicator from the UE in a UE capability message indicating whether the UE supports NES CHO or whether the cell does not support NES operation (step 1201). Alternatively, the serving base station may receive an indicator in the UEAssistanceInfo message indicating a preference for NES CHO or a non-preference for NES operation of the cell. Based on the indictors, the serving base station may determine whether the base station can support NES CHO operation (step 1202).

If NES CHO support for the UE is available, or if NES operation of the cell is not wanted or may not be supported, NES CHO may be configured for the UE. Otherwise, the NES CHO is not configured for that UE (step 1203).

If a UE wants to configure a NES CHO, the serving base station may determine the NES CHO candidate cells (step 1204). This process may be performed in conjunction with the general CHO determination. An HO Request message may be sent to the base station of the determined candidate cell (step 1205), and an HO Request ACK message may be received from the base station of the candidate cell (step 1206). This ACK message may include configuration information of the candidate target cell. If the general CHO determination and HOReq message transmission/HOReqACK message reception was for general CHO only, then some of the general CHO candidate cells containing the received HOReqACK message may be further determined to be NES CHO candidate cells (step 1207).

The NES CHO candidate cell configuration information may be delivered to the UE (step 1208). At this time, the serving base station may add condition information and ID information for each NES CHO candidate cell and deliver the information to the UE.

The UE may receive the message and deliver the RRCReconfigurationComplete message, and the serving base station may receive the message (step 1209).

At some point thereafter, a turn-off indicator may be sent (step 1210). Accordingly, the UE may perform the NES CHO. And after a certain time margin, the serving base station transitions to its turn-off state (step 1211).

Methods according to embodiments described in the claims or specification of the present disclosure may be implemented in the form of hardware, software, or a combination of hardware and software.

When implemented as software, a computer-readable storage medium that stores one or more programs (software modules) may be provided. One or more programs stored in a computer-readable storage medium are configured to be executable by one or more processors in an electronic device (configured for execution). One or more programs include instructions that enable the electronic device to execute methods according to embodiments described in the claims or specification of the present disclosure.

These programs (software modules, software) may be stored in random access memory, non-volatile memory including flash memory, read only memory (ROM), and electrically erasable programmable read only memory (EEPROM), magnetic disc storage device, compact disc-ROM (CD-ROM), digital versatile discs (DVDs), or other types of optical storage device or magnetic cassette. Alternatively, it may be stored in a memory consisting of a combination of some or all of these. In addition, each configuration memory may include multiple units.

In addition, the program may be operated through a communication network such as an Internet, an Intranet, a local area network (LAN), a wide LAN (WLAN), or a storage area network (SAN), or a combination thereof. It may be stored on an attachable storage device that is accessible. This storage device may be connected to a device performing an embodiment of the present disclosure through an external port. In addition, a separate storage device on a communication network may be connected to the device performing an embodiment of the present disclosure.

In the specific embodiments of the present disclosure described above, components included in the disclosure are expressed in singular or plural numbers depending on the specific embodiment presented. However, as the singular or plural expressions are selected to suit the presented situation for convenience of explanation, the present disclosure is not limited to singular or plural components, and even the components expressed in plural may be composed of the singular elements and even components expressed in singular may be composed of plural elements.

Meanwhile, in the detailed description of the present disclosure, specific embodiments have been described, but of course, various modifications are possible without departing from the scope of the present disclosure. Therefore, the scope of the present disclosure should not be limited to the described embodiments, but should be determined not only by the scope of the patent claims described later, but also by the scope of this patent claim and equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, a radio resource control (RRC) message including a configuration associated with a conditional handover (CHO);
identifying whether an event is satisfied based on the configuration; and
performing the CHO in case that the event is satisfied.

2. The method of claim 1, wherein the event is satisfied in case that downlink control information (DCI) including an indication associated with a network energy saving (NES) is received from the base station.

3. The method of claim 1, wherein the configuration associated with the CHO includes information indicating the event associated with a NES CHO.

4. The method of claim 2, wherein the indication associated with the NES comprises a 1 bit.

5. A method performed by a base station in a wireless communication system, the method comprising:
transmitting, to a user equipment (UE), a radio resource control (RRC) message including a configuration associated with a conditional handover (CHO); and
performing the CHO in case that an event is satisfied based on the configuration.

6. The method of claim 5, wherein the event is satisfied in case that downlink control information (DCI) including an indication associated with a network energy saving (NES) is transmitted to the UE.

7. The method of claim 5, wherein the configuration associated with the CHO includes information indicating the event associated with a NES CHO.

8. The method of claim 6, wherein the indication associated with the NES comprises a 1 bit.

9. A user equipment (UE) in a wireless communication system, the UE comprising:
a transceiver; and
a controller operably connected to the transceiver, the controller configured to:
receive, from a base station, a radio resource control (RRC) message including a configuration associated with a conditional handover (CHO),
identify whether an event is satisfied based on the configuration, and
perform the CHO in case that the event is satisfied.

10. The UE of claim 9, wherein the event is satisfied in case that downlink control information (DCI) including an indication associated with a network energy saving (NES) is received from the base station.

11. The UE of claim 9, wherein the configuration associated with the CHO includes information indicating the event associated with a NES CHO.

12. The UE of claim 10, wherein the indication associated with the NES comprises a 1 bit.

13. A base station in a wireless communication system, the base station comprising:
a transceiver; and
a controller operably connected to the transceiver, the controller configured to:
transmit, to a user equipment (UE), a radio resource control (RRC) message including a configuration associated with a conditional handover (CHO), and
perform the CHO in case that an event is satisfied based on the configuration.

14. The base station of claim 13, wherein the event is satisfied in case that downlink control information (DCI) including an indication associated with a network energy saving (NES) is transmitted to the UE.

15. The base station of claim 13, wherein the configuration associated with the CHO includes information indicating the event associated with a NES CHO.

16. The base station of claim 14, wherein the indication associated with the NES comprises a 1 bit.
